(19) United States
(12) Patent Application Publication
(10) Pub. No.: US 2016/0299165 A1
(43) Pub. Date: Oct. 13, 2016

(54) BIOCHIP DETECTION SYSTEM

(71) Applicant: ZHUHAI DL BIOTECH. CO., LTD., Zhuhai, Guanfdong (CN)

(72) Inventor: Ping ZHOU, Guangdong (CN)

(73) Assignee: ZHUHAI DL BIOTECH. CO., LTD., Zhuhai, Guangdong (CN)

(21) Appl. No.: 15/038,578

(22) PCT Filed: Jun. 11, 2014
(86) PCT No.: PCT/CN2014/079656

§ 371 Date: May 23, 2016

(30) Foreign Application Priority Data
Apr. 11, 2014 (CN) 201410146509.7
Apr. 11, 2014 (CN) 201410146658.3
Apr. 11, 2014 (CN) 201410146940.1

(51) Int. Cl. G01N 35/00; B01L 3/00; B01L 7/00; G01N 35/10

(52) U.S. Cl. CPC G01N 35/00871; G01N 35/1016; G01N 35/1004; G01N 35/00663; B01L 3/502; B01L 7/00; G01N 2035/00346; G01N 2035/00891; G01N 2035/00673; B01L 2200/0605; B01L 2400/0475; B01L 2300/0672; B01L 2400/06; B01L 2400/0605; B01L 2300/1805; B01L 2300/123; B01L 2200/147

(57) ABSTRACT

A biochip detection system may comprise a motion execution system, a fluid control system, a temperature control system, an air knife cleaning device, a biochip scanning system and a computer control system which are mounted in a system case. The computer control system may control the motion execution system, the fluid control system, the temperature control system, the air knife cleaning device and the biochip scanning system via electrical connections. The biochip detection system may compactly integrate all executive mechanisms and control devices within a small case, achieving complete isolation and fully automated execution in a detection process and completing all the following detection steps in one operation: sampling, washing, cleaning, heating, cooling, scan imaging, etc., thus effectively improving the detection accuracy while greatly reducing manual operations in the entire process.

### FIELD OF THE INVENTION

The present invention relates to medical detection equipment, and in particular to a biochip detection system.

### BACKGROUND OF THE INVENTION

At present, a detection work of a biochip requires of work processes with multiple steps including sampling, washing, reacting, heating, cooling, cleaning, scan imaging, etc., due to various devices and instruments related thereto, the detection efficiency is very low. Moreover, the detection results are extremely easy to be influenced by manual operation and environmental change during the processes, so, people have been making continuous efforts to design a set of perfect detection system for the detection of the biochip, in order to be more convenient for completing all the processes in a detection process, to reduce workload, working hours and manual misoperation to an extreme, to improve the control accuracy of the detection results, to enhance the work efficiency and to save the consumption of reagents.

For achieving the normal operation of a biochip detection system requiring of many operation equipment and detection and preparation devices, an electronic control device configured to connect the operation equipment and detection and preparation devices and a computer control system, the full automation in the detection process may be correctly and efficiently achieved by improving cooperation between a mechanical portion and an electric control portion. Some biochip detection systems in the prior art, regarding an open operation desk as a platform for carrying out detection of the biochip, are not easy to be moved but are large in volume resulted in larger occupied space; all the processes for a sample may not be completed directly on a single device during a working process, but the sample needs to be manually transferred to several process equipment, as a result, the system may not achieve automatic operation or keep enough isolation from the outside all the time, thereby easily influencing the detection results.

### SUMMARY OF THE INVENTION

In order to overcome the defects of the existing art, the present invention provides a biochip detection system, providing batch detections with high isolation, high efficiency and high accuracy for biochip detection, without manual sample manipulation during the detection.

A technical solution employed by the present invention to solve the technical problems can be described as follows.

A biochip detection system according to the invention comprises a motion execution system, a fluid control system, a temperature control system, an air knife cleaning device, a biochip scanning system and a computer control system, which are mounted within a system case.

Specifically, the motion execution system comprises an X-axis linear execution mechanism, a Y-axis linear execution mechanism and a Z-axis linear execution mechanism, which are arranged perpendicularly to each other along a X-axis direction, a Y-axis direction and a Z-axis direction respectively, wherein the X-axis linear execution mechanism is fixedly mounted on one side of the system case in the Y-axis direction, and comprises a first mobile seat movable along the X-axis direction. The Y-axis linear execution mechanism is arranged above the X-axis linear execution mechanism, secured to the first mobile seat by one end thereof, and provided with a mobile bracket on another end thereof. The motion execution system further comprises a guide rail parallel with the X-axis linear execution mechanism and arranged on another side of the system case in the Y-axis direction, wherein the mobile bracket is slidably mounted on the guide rail by a bottom end thereof, the X-axis linear execution mechanism drives the Y-axis linear execution mechanism to move in a form of a gantry. The Y-axis linear execution mechanism comprises a second mobile seat moveable along the Y-axis direction mounted thereon, the Z-axis linear execution mechanism is vertically mounted on the second mobile seat from one side of the Y-axis linear execution mechanism, and the Z-axis linear execution mechanism comprises a third mobile seat moveable along the Z-axis direction mounted thereon.

The fluid control system comprises a plurality of miniature pumps configured to suck liquid, fine control valves configured to control flow rate, and liquid adding pipes configured to connect the miniature pumps and the fine control valves for transferring the liquid, wherein the miniature pumps and the fine control valves are respectively mounted on a mounting box and a mounting plate which are fixedly connected to the second mobile seat and the third mobile seat respectively. The mounting box is provided with a plurality of liquid bottles for containing the liquid, the miniature pumps are connected to the liquid bottles and the fine control valves respectively through the liquid adding pipes. The fluid control system further comprises a sampling needle plate mounted on a bottom end of the mounting plate, and pipe orifices of the liquid adding pipes are concentratedly fixed on the sampling needle plate.

The temperature control system comprises an upper heating plate and a lower heating plate which are abutted with each other, and a rotating shaft device through which one end of the upper heating plate and one end of the lower heating plate are hingedly connected. The upper heating plate is openable and closable along with the rotation of the rotating shaft device, and the lower heating plate is fixedly connected to the system case. The rotating shaft device is arranged on one side of the system case in the X-axis direction, and provided with a motor arranged therein for driving the rotating shaft device to rotate. The Y-axis linear execution mechanism has an original position set on another side of the system case in the X-axis direction. The temperature control system further comprises first heating elements arranged on both of the upper heating plate and the lower heating plate correspondingly for heating, the lower heating plate is further provided with a plurality of clamping grooves for receiving the biochips, corresponding to the first heating elements. The temperature control system further comprises temperature sensors configured to detect the temperature, and a heat radiator arranged below the lower heating plate.

The air knife cleaning device comprises an air knife mounted on a bottom end of the third mobile seat, and an air pump arranged below the original position of the Y-axis linear execution mechanism, wherein the air pump is connected to the air knife through an air pipe and an electromagnetic switch valve for controlling air flow.

The biochip scanning system comprises a video camera and an intensifying device which are mounted on the third mobile seat.

The computer control system comprises a display, a computer, an electrical electronic controller and a manipulating device, controlling the motion execution system, the fluid control system, the temperature control system, the air knife cleaning device and the biochip scanning system via electrical connections.

As an improvement to the technical solution, the system case consists of an execution case and an electronic control case. The motion execution system, the fluid control system, the temperature control system, the air knife cleaning device and the biochip scanning system are all mounted in the execution case, while the computer control system is mounted in the electronic control case. The execution case and the electronic control case are provided with several connection port groups detachable quickly through cables in a matching manner, and the execution case is further provided with an opening mechanism capable of opening and closing.

As a further improvement to the technical solution, the opening mechanism is hinged on the execution case in a rotating manner, a gas spring is connected between the opening mechanism and the execution case, and a light tube configured to illuminate is arranged inside the execution case.

Further, a motor and a screw rod driven by the motor are arranged in each of the X-axis linear execution mechanism, the Y-axis linear execution mechanism and the Z-axis linear execution mechanism. The first mobile seat, the second mobile seat and the third mobile seat are respectively connected to the screw rods of the X-axis linear execution mechanism, the Y-axis linear execution mechanism and the Z-axis linear execution mechanism. The Y-axis linear execution mechanism is further provided with a first drag chain and a second drag chain for protecting the movement of the cables and the air pipes, and the two ends of the first drag chain are respectively connected to the Y-axis linear execution mechanism and the system case. The second drag chain is arranged along the Y-axis linear execution mechanism, of which the two ends are respectively connected to the Y-axis linear execution mechanism and the second mobile seat.

Further, the mounting box is further provided with a waste liquid bottle, a liquid suction pump, a liquid suction valve for recycling waste liquid, and a cleaning solution bottle and a cleaning solution pump for providing cleaning solution to the liquid adding pipes for cleaning, and a plurality of double check valves accordingly connected between the fine control valves and the miniature pumps. The waste liquid bottle is connected to the liquid suction pump through a waste liquid pipe, a tail end of the waste liquid pipe is fixed on the sampling needle plate, passing through the liquid suction pump. The cleaning solution bottle is connected to the cleaning solution pump through a cleaning solution pipe, then connected in parallel to the double check valves and finally connected to the liquid adding pipes. The system case is provided with a cleaning bottle located below the original position of the Y-axis linear execution mechanism.

Further, the first heating elements of the lower heating plate are fastened and abutted on the bottom surface of the lower heating plate, and the temperature sensor is arranged in the center of the bottom surface of the lower heating plate. The lower heating plate is further provided with a travel switch configured to control the heating of the heating plates, and a circular groove which encircles the clamping grooves and receives an elastic sealing strip. In the clamping grooves, inclined planes which facilitate taking the biochips out are arranged. The heat radiator is provided with a plurality of fans 36 for blowing air in a direction directly facing the bottom surface of the lower heating plate, and corresponding to the fans, a plurality of vent holes are arranged at the bottom of the system case.

Further, the rotating shaft device is of a hollow structure, and provided with some axis holes and wire holes for leads passing.

Further, a filter configured to remove air particles, an air bag configured to store compressed air, and a pressure regulating valve configured to regulate the output pressure, are successively connected between the air pump and the air knife, wherein the pressure regulating valve is further connected to a gas-pressure meter configured to display the gas pressure value in real time.

Further, the air knife is in a wedge shape, and provided with a plurality of air jet holes and circulating holes which are arranged side by side at a pointed end and two side faces thereof.

Further, the intensifying device is arranged below the video camera, and provided with a lens and a light source for the video camera.

The beneficial effects of the present invention are as follows: the product has high integration level, compactly integrates each executive mechanism and control device in a small case, achieves complete isolation and fully automated execution in a detection process and completes all the following detection steps in one operation: sampling, washing, cleaning, heating, cooling, scan imaging, etc., thus effectively improving the detection accuracy while greatly reducing the manual operation of the entire process; moreover, the volume and size thereof are moderate, and therefore the product may be easily transported or transferred and is suitable for hospitals, research institutions or many other places.

### BRIEF DESCRIPTION OF THE DRAWINGS

The present invention is further described as below with reference to the accompanying drawings and embodiments.

FIG. 1 is a schematic view of the system of the invention;

FIG. 2 is a schematic view of a motion execution system of the invention under a mounting condition;

FIG. 3 is a schematic view of the motion execution system of the invention under a mounting condition from another point of view;

FIG. 4 is an internal schematic view of an X-axis linear execution mechanism of the invention;

FIG. 5 is an internal schematic view of a Y-axis linear execution mechanism of the invention;

FIG. 6 is a schematic view of a fluid control system of the invention under a mounting condition;

FIG. 7 is a schematic view of a mounting box of the fluid control system of the invention under a mounting condition;

FIG. 8 is a schematic view of a temperature control system of the invention under a mounting condition;

FIG. 9 is a sectional view of a lower heating plate of the invention;

FIG. 10 is a local sectional view of a rotating shaft device of the invention;

FIG. 11 is a schematic view of an air knife cleaning device and a biochip scanning system of the invention under a mounting condition;

FIG. 12 is a structure diagram of a mounting condition of components such as an air pump in the air knife cleaning device of the present invention;

FIG. 13 is a schematic view of an air knife of the invention;

FIG. 14 is an exploded view of the temperature control system of the invention under a mounting condition;

FIG. 15 is a back view of a lower heating plate of the temperature control system of the invention; and

FIG. 16 is a back view of an upper cover plate of the temperature control system of the invention.

### DESCRIPTION OF THE PREFERRED EMBODIMENT

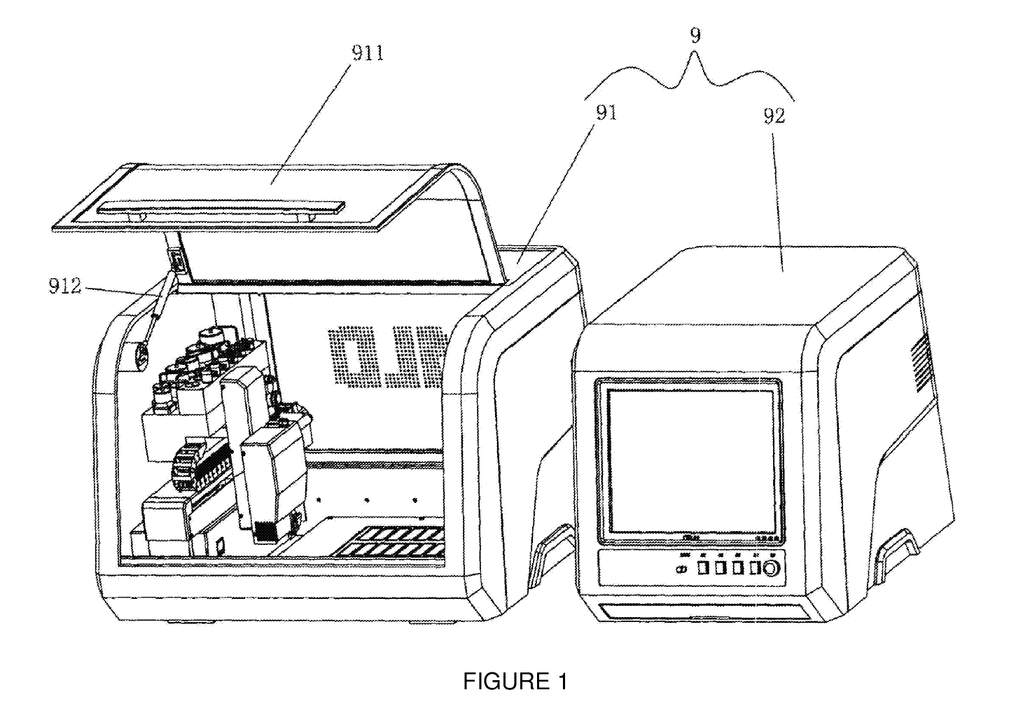

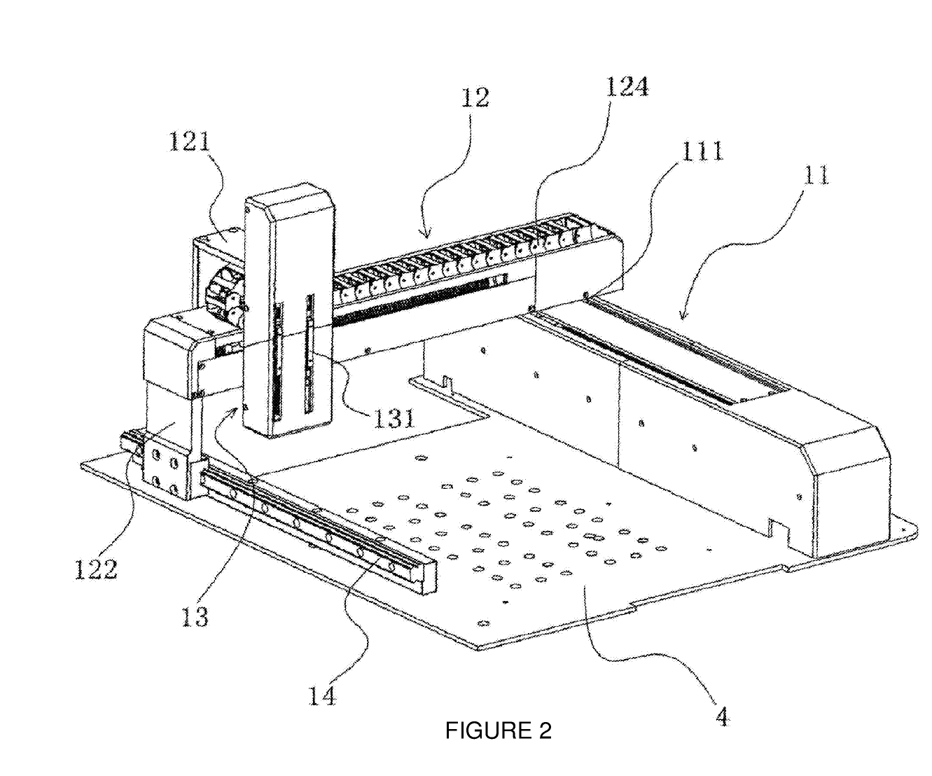

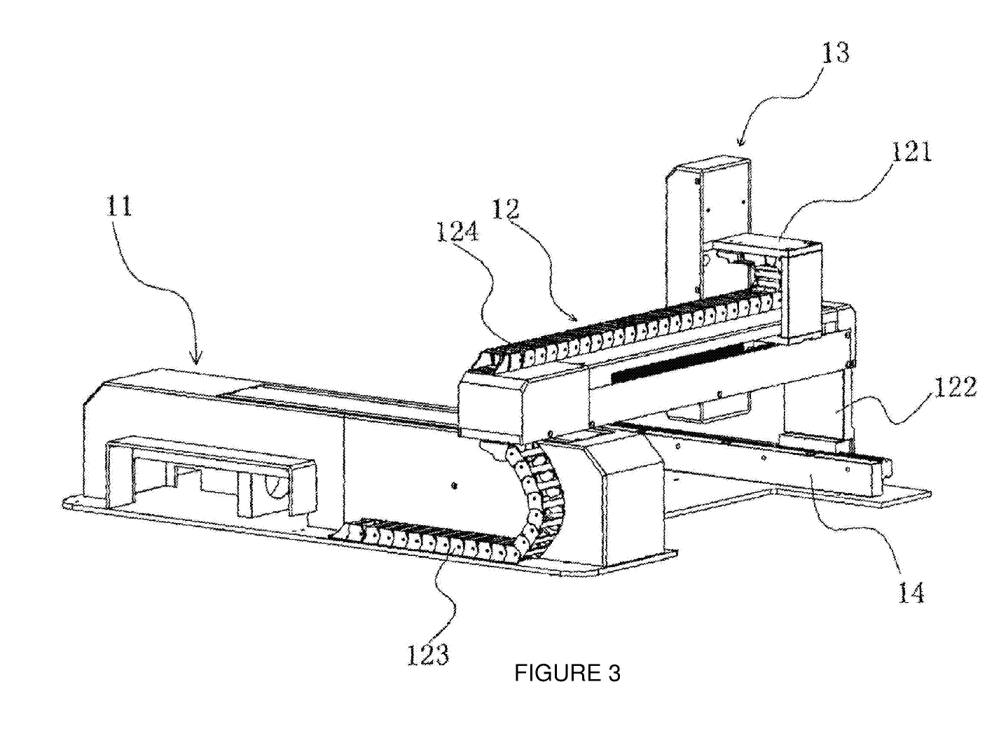

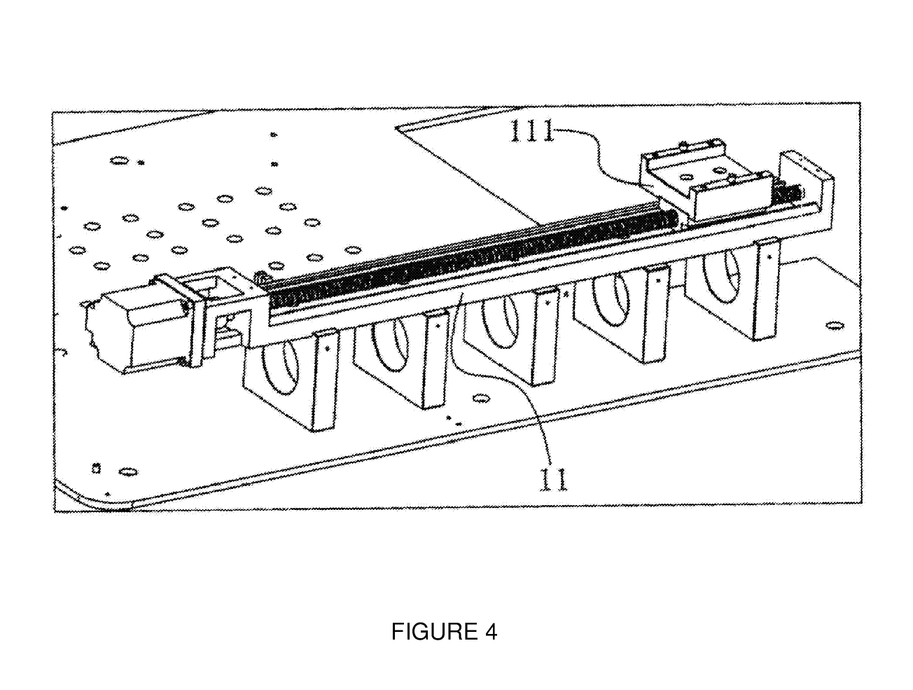

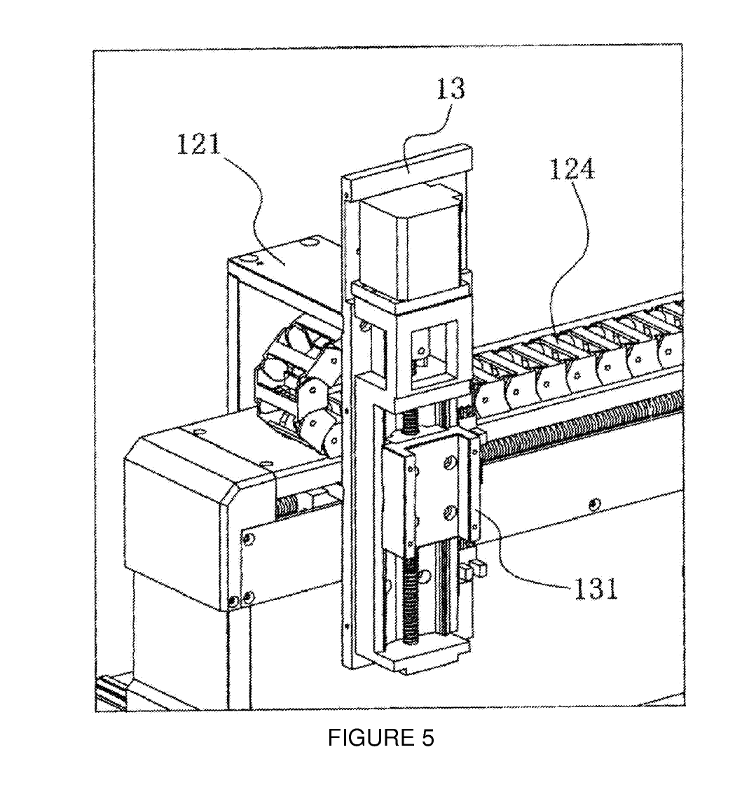

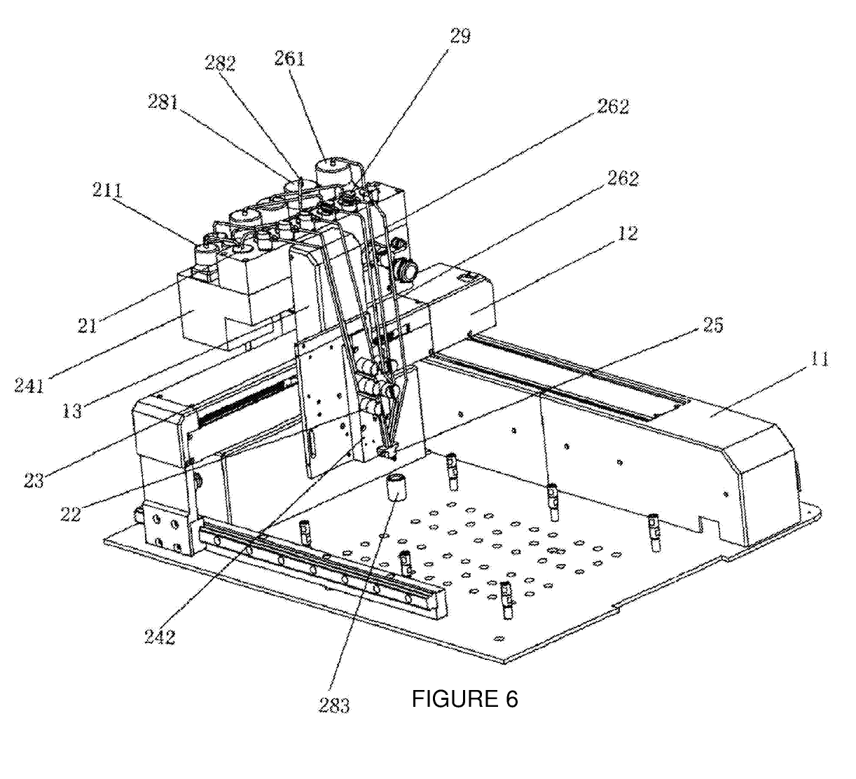

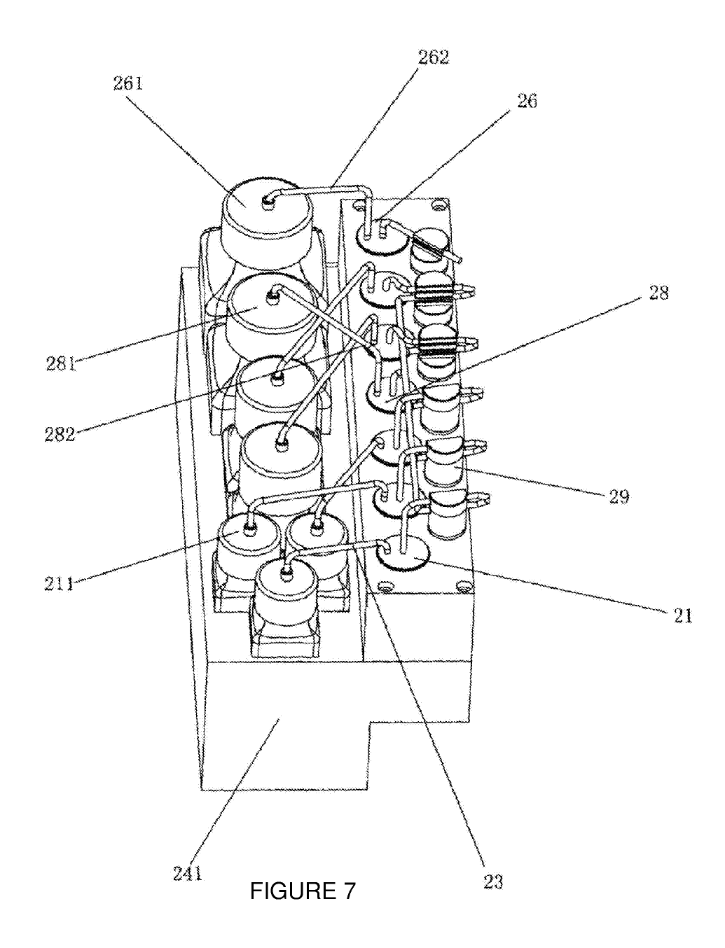

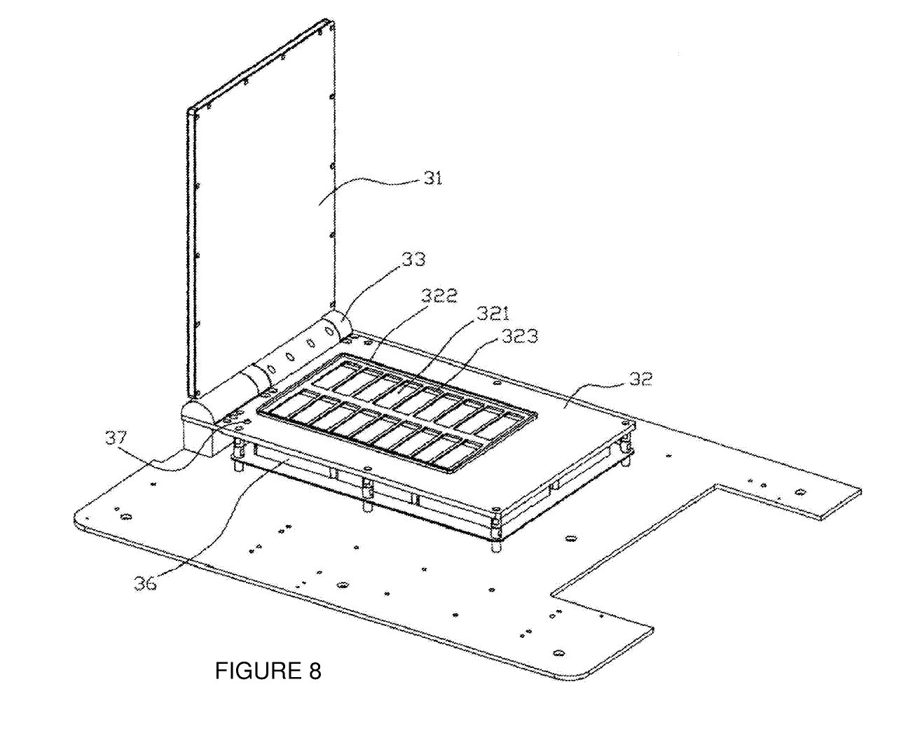

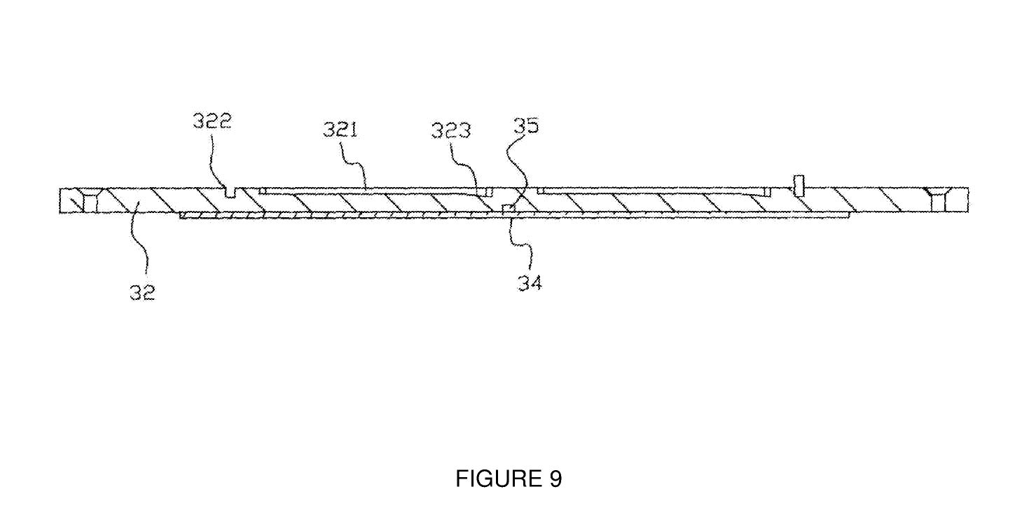

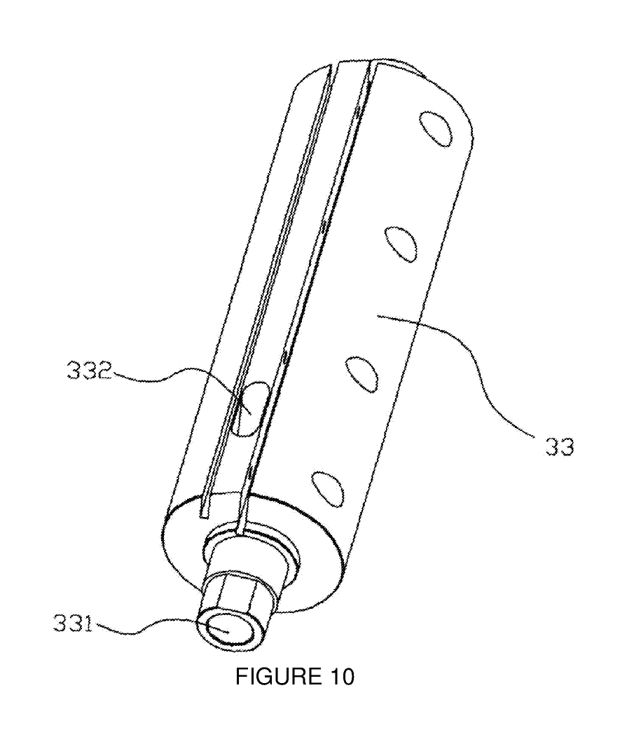

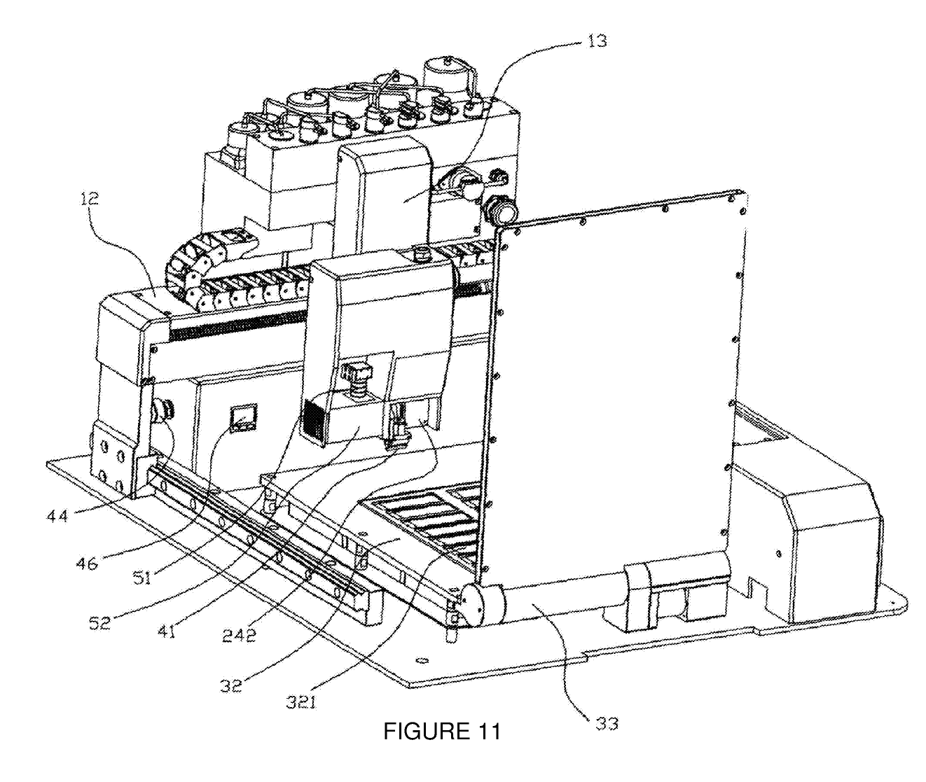

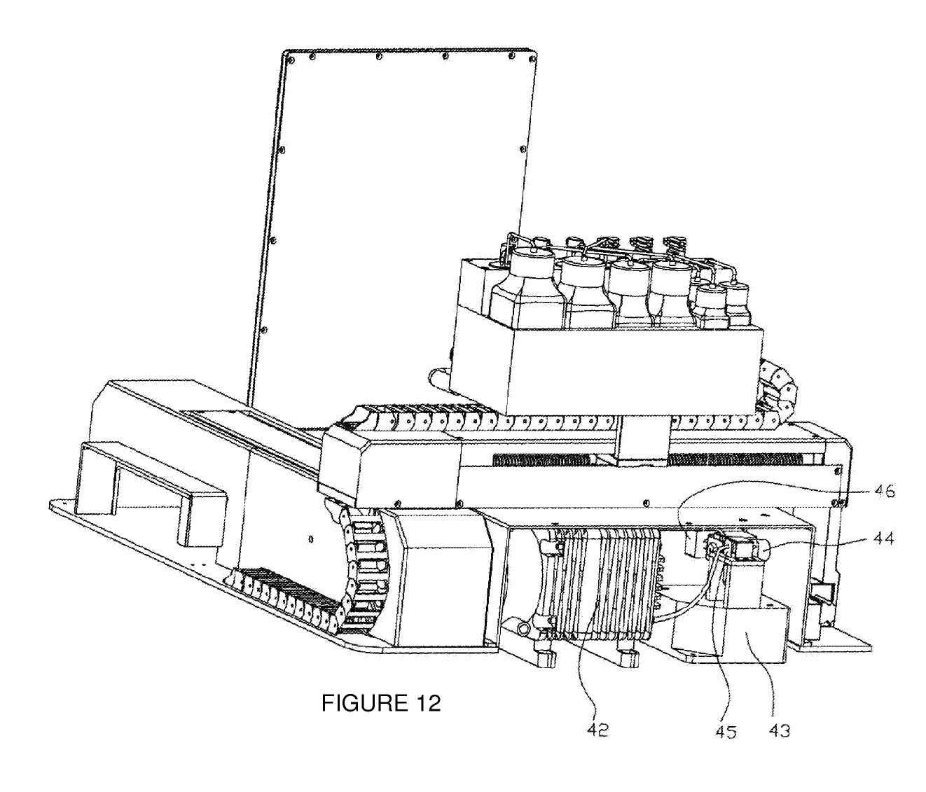

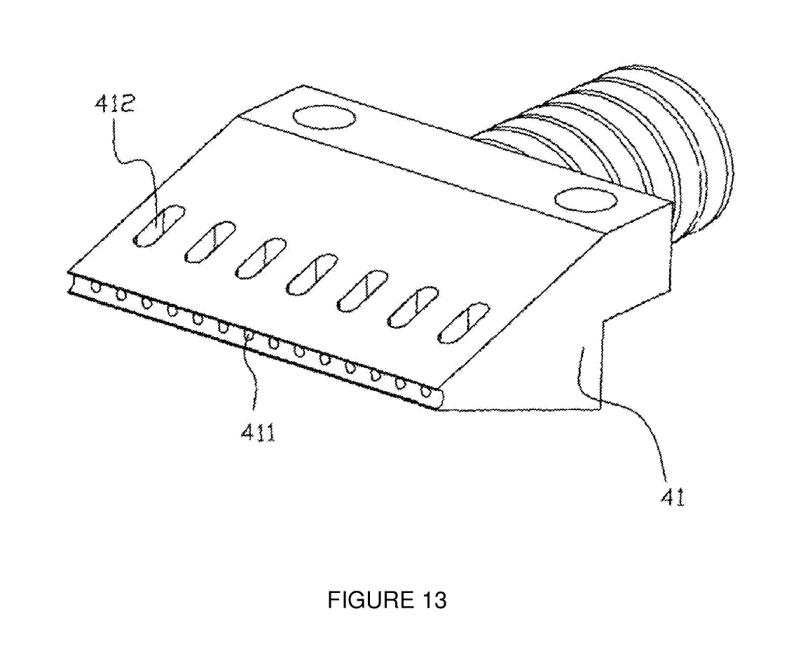

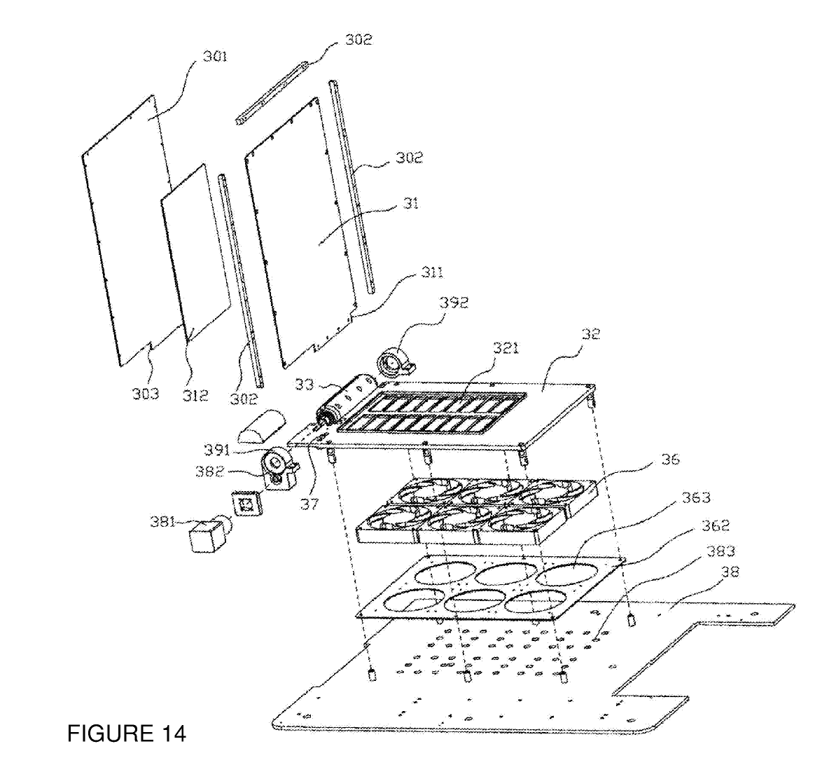

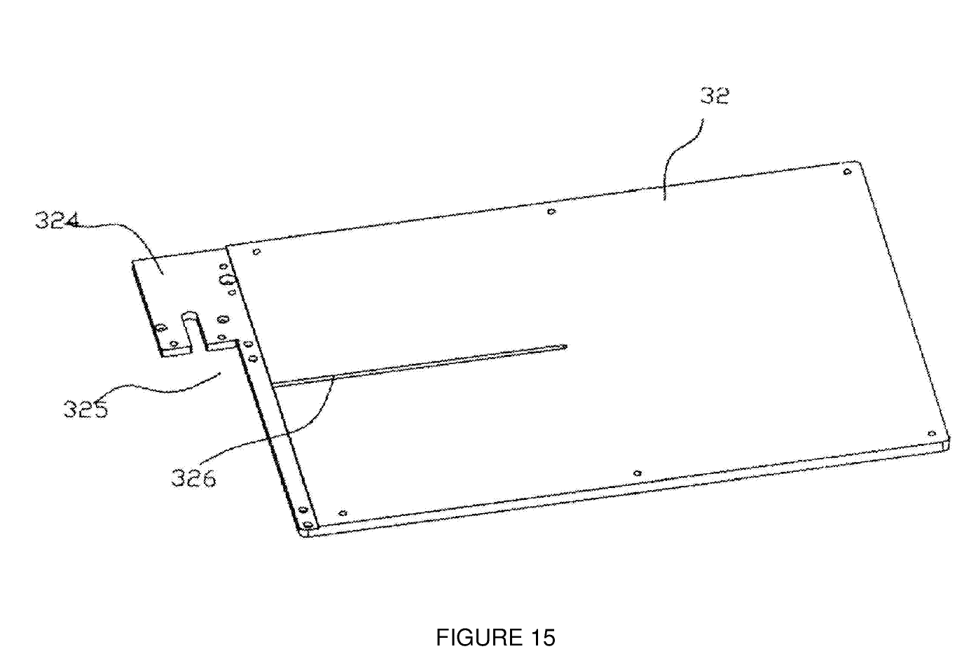

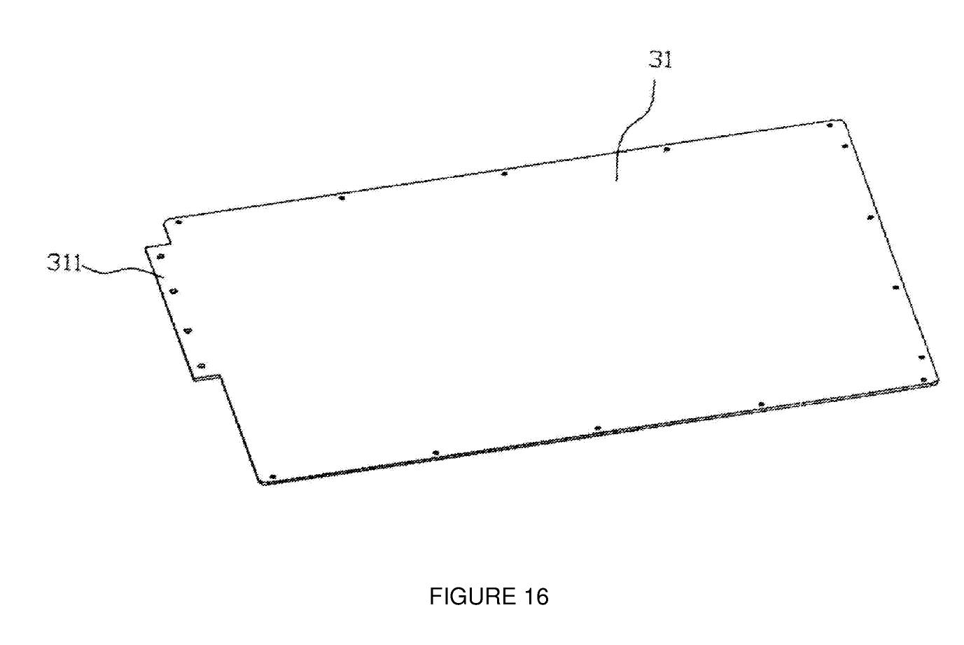

As shown in FIG. 1 to FIG. 16, a biochip detection system according to the invention comprises a motion execution system, a fluid control system, a temperature control system, an air knife cleaning device, a biochip scanning system and a computer control system which are mounted in a system case 9. These sub systems are compactly integrated in the system case 9 to carry out various detection processes and provide better protection in movement or transportation. As all are integrated in one as a whole, the system is controlled in size and thus its applicability is enhanced. The system case 9 may be provided with a structure such as cabin door or window to place the biochips therein.

The motion execution system comprises an X-axis linear execution mechanism 11, a Y-axis linear execution mechanism 12 and a Z-axis linear execution mechanism 13, arranged perpendicularly to each other along an X-axis direction, a Y-axis direction and a Z-axis direction respectively. The X-axis linear execution mechanism 11 is fixedly mounted on one side of the system case in the Y-axis direction, and comprises a first mobile seat 111 movable along the X-axis direction. The Y-axis linear execution mechanism 12 is arranged above the X-axis linear execution mechanism 11, secured to the first mobile seat 111 by one end thereof, and provided with a mobile bracket 122 on another end thereof. The motion execution system further comprises a guide rail (14) parallel with the X-axis linear execution mechanism 11 and arranged on another side of the system case 9 along the Y-axis direction, wherein the mobile bracket 122 is slidably mounted on the guide rail 14 by a bottom end thereof, the X-axis linear execution mechanism 11 drives the Y-axis linear execution mechanism 12 to move in a form of a gantry. The Y-axis linear execution mechanism 12 further comprises a second mobile seat 121 moveable along the Y-axis direction mounted thereon, the Z-axis linear execution mechanism 13 is vertically mounted on the second mobile seat 121 from one side of the Y-axis linear execution mechanism 12, and the Z-axis linear execution mechanism 13 comprises a third mobile seat 131 mounted thereon and moveable along the Z-axis direction. The third mobile seat 131 may move arbitrarily within the system case 9 through the movement of the three execution mechanisms, thus allowing a spatial movement and facilitating the mounting of the fluid control system to carry out sampling in batches.

The fluid control system comprises a plurality of miniature pumps 21 configured to suck liquid, fine control valves 22 configured to control flow rate, and liquid adding pipes 23 configured to transfer liquid and connect the miniature pumps 21 and the fine control valves 22, wherein the miniature pumps 21 and the fine control valves 22 are respectively mounted on a mounting box 241 and a mounting plate 242 which are respectively fixedly connected to the second mobile seat 121 and the third mobile seat 131. The mounting box 241 is provided with a plurality of liquid bottles 211 loaded with the liquid arranged thereon. Correspondingly, the miniature pumps 21 are connected to the liquid bottles 211 and the fine control valves 22 through the liquid adding pipes 23, respectively. The fluid control system further comprises a sampling needle plate 25 mounted on a bottom end of the mounting plate 242, and the pipe orifices of the liquid adding pipes 23 are concentratedly fixed on the sampling needle plate 25. The entire fluid control system is moved along with the Z-axis linear execution mechanism 13 in real time, in which all the liquid adding pipes 23 will not extend-retract or swing with the sampling needle plate 25. The mounting box 241, the mounting plate 242, as well as the liquid bottles 211, the miniature pumps 21 and the fine control valves 22 of a number as required, and the liquid adding pipes 23 connected, allow a fast and accurate sampling process.

The fluid control system further comprises a liquid suction pump 26 configured to suck the sampled liquid. The liquid suction pump 26 is connected to a waste liquid bottle 261 configured to recycle the waste liquid and the fine control valves 22 through liquid suction pipes. The tail ends of the liquid suction pipes passing through the fine control valves 22 are fixed on the sampling needle plate 25. Since the biochips will only react with an extremely small amount of the sampling liquid during the process of sampling the liquid droplet, and the liquid droplet may be sucked back by the liquid suction pipes instantly, the pollution and adverse effects on the samples detected are avoided. Moreover, the liquid adding pipes 23 for sampling the liquid droplet may be cleaned by the cleaning solution flowing through the liquid adding pipes, and the cleaning solution flowed out from the liquid adding pipes 23 is recycled in the waste liquid bottle 261 through the liquid suction pipes, thus achieving an automatic control on the liquid treatment.

Preferably, the liquid bottles 211 and the waste liquid bottle 261 are placed on a mounting box 241, and a mounting base on which the miniature pumps 21 and the liquid suction pump 26 are mounted is arranged on the mounting box 241. The fine control valves 22 and the sampling needle plate 25 are respectively fixedly connected to a middle section and a bottom end of the mounting plate 242, the mounting plate 242 and the mounting box 241 are fixed on a mobile manipulator moveable spatially. The mounting plate 242 is vertically connected to one side of a bottom end of the mobile manipulator, and the mounting box 241 is connected to one side of a top end of the mobile manipulator. On the one hand, the liquid bottles 211, the waste liquid bottle 261, the miniature pumps 21 and the liquid suction pump 26 may respectively move along with the mobile manipulator by means of the mounting box 241 and the mounting base. On the other hand, the fine control valves 22 and the sampling needle plate 25 are fixed on a bottom end of the mobile manipulator by the mounting plate 242, such that the entire fluid control system is integrated on the mobile manipulator to facilitate the sampling of liquid droplet, as well as to enable the liquid adding pipes 23 and the liquid suction pipes to work more accurately, and further to facilitate the changing of the liquid bottles 211 and the waste liquid bottle 261.

Further, the liquid adding pipes 23 between the miniature pumps 21 and the fine control valves 22 are further provided with double check valves 29 which select the pipes for liquid passing through. The double check valves 29 are simultaneously connected with two liquid adding pipes 23 for transferring the cleaning solution and the sampling liquid respectively. The liquid adding pipe 23 for transferring the cleaning solution is connected to a cleaning pump configured to supply the cleaning solution alone, the two liquid adding pipes 23 passing through the double check valves 29 are jointed in parallel into one and then connected in parallel to the fine control valves 22. Thus, as long as one liquid bottle 211 loaded with the cleaning solution is arranged, it may achieve transferring the cleaning solution to each of the liquid adding pipes 23 by in parallel connecting the liquid adding pipes 23 to each of the double check valves 29 through the cleaning pump.

Furthermore, the double check valves 29 together with the fine control valves 22 which is connected to the liquid suction pump 26 are mounted on the mounting base.

The system is further provided with a liquid containing bottle which is configured to correspondingly receive the liquid drained from the liquid adding pipes 23 and arranged below the mobile manipulator. The liquid containing bottle may be used in the test of the liquid adding pipes 23 for transferring liquid or recycling the spot sample liquid and the cleaning solution, so as to keep the medical detection equipment clean.

Further, the liquid containing bottle is arranged below the mobile manipulator at its original position, to avoid liquid leakage of the liquid adding pipes 23 influencing the interior of the medical detection equipment when the mobile manipulator is in the original position. In addition, the original position is the most appropriate place to arrange the liquid containing bottle, thus facilitating other execution mechanisms of the medical detection equipment.

The temperature control system for medical detection equipment comprises a lower heating plate 32, an upper heating plate 31, a driving device and a heat radiator. The lower heating plate 32 is fixedly mounted within the case of the medical detection equipment. The temperature control system further comprises a first heating element 34 for heating, mounted on a lower end face of the lower heating plate 32. The lower heating plate 32 has a heating region in a position on an upper end face thereof corresponding to where the first heating element 34 is located, on which clamping grooves 321 where the biochips are placed are arranged. The upper heating plate 31, which may be opened and closed relative to the lower heating plate 32, is hingedly mounted on one end of the lower heating plate 32. The driving device is configured to drive the upper heating plate 31 to rotate, comprising a motor 381 and a transmission mechanism 382. The heat radiator is arranged below the lower heating plate 32, comprising a radiator mounting rack 362 fixedly connected to the lower heating plate 32, and a plurality of radiator fans 36 mounted on the radiator mounting rack 362. The radiator mounting rack 362 is provided with a plurality of vent holes 363 in positions corresponding to where the radiator fans 36 are arranged. Preferably, a fixing plate 38 is fixedly connected to and arranged below the radiator mounting rack 362, the heat radiator and the lower heating plate 32 may be mounted in the case through a fixed connection of the fixing plate 38 to the case of the medical detection equipment. A heat radiating mechanism 383 configured to facilitate air to enter is arranged in a position of the fixing plate 38 corresponding to where the radiator fans 36 are arranged. During heat dissipating, the air goes into the radiator fans 36 from outside through the heat radiating mechanism 383 on the fixing plate 38 and the vent holes 363 on the radiator mounting rack 362 after entering the case, and then is blown to the first heating elements 34 by the radiator fans 36.

In the present invention, the upper heating plate 31 is hingedly mounted on the lower heating plate 32, and the transmission mechanism 382 is driven by the motor 381 to rotate the upper heating plate 31, thus achieving the opening and closing operations of the upper heating plate 31 with respect to the lower heating plate 32. The invention has the advantages of simple and compact structure, small size, low production costs and easy operation without manually opening and closing the upper heating plate 31. The upper heating plate 31 is lidded on the lower heating plate 32 during heating, effectively reducing heat loss and waste, and providing higher heating efficiency. Moreover, the heat radiator is arranged below the lower heating plate 32, the air flow blown out from the radiator fans 36 is immediately in contact with the first heating elements 34 fixedly mounted on the lower end face of the lower heating plate 32, providing excellent heat dissipation effect, i.e. quickly dissipating the heat on the lower heating plate 32 to avoid over-temperature, prolonging service life, preventing users from being scalded, and enhancing safety.

Further, for higher heating efficiency and to prevent the heat from leaking from a slit between the upper heating plate 31 and the lower heating plate 32, the lower heating plate 32 is provided with a circular groove 322 formed on a periphery of the heating region thereof, and an elastic sealing element embedded into the circular groove 322. The elastic sealing element is pressed by the lower heating plate 32 to deform so as to seal the heating region when the upper heating plate 31 is closed on the lower heating plate 32. During heating, the upper heating plate 31 is rotated to lid on the lower heating plate 32, and presses the elastic sealing element under the effect of gravity to deform, so as to seal the heating region. This arrangement is characterized in an excellent sealing effect and consequently an excellent heating effect as the temperature in the heating region may stay the same.

Further, the clamping groove 321 is provided with a bevel 323 sloping downward on a upper bottom surface at one end thereof to facilitate the article heated to escape from the clamping groove 321 from another end opposite to said end while the article is pressed at said end. With this structure, a user may manually take the heated article out from the clamping groove 321 by pressing the heated article at one end of the clamping groove 321 where the bevel 323 is provided to upwarp the heated article at another end, without the aid of a tool, the manipulation is rapid and convenient.

Further, the upper heating plate 31 is flexibly connected to one end of the lower heating plate 32 through the rotating shaft device 33, and the rotating shaft device 33 is flexibly connected to a first supporting seat 391 and a second supporting seat 392 through bearings on two ends thereof. The first supporting seat 391 is close to the motor 381 and fixedly mounted on the lower heating plate 32 along with the second supporting seat 392. The two ends of the rotating shaft device 33 are mounted through bearings on the first supporting seat q391 and the second supporting seat 392 on the lower heating plate 32, thus reducing friction generated during the opening and closing processes of the upper heating plate 31, and prolonging the service life of the device of the present invention. Preferably, in order to facilitate the mounting of the driving device, a mounting flange 324 for fixedly mounting a motor 381 is arranged on one end of the lower heating plate 32 where the rotating shaft device 33 is connected, and a notch 325 is formed on one side of the lower heating plate 32 where the mounting flange 324 is mounted. The rotating shaft device 33, the first supporting seat 391 and the second supporting seat 392 are all arranged in the notch 325. The driving device is a reduction gear set and mounted in the first supporting seat 391, such that the system has a compact integral structure and aesthetic appearance, and facilitates laying leads.

Further, for higher heating efficiency of the heating system, the system further comprises a second heating elements 312 mounted in a position on a back side of the upper heating plate 31 corresponding to where the first heating element 34 is located, a shield plate 301 fixedly connected to the upper heating plate 31 and arranged on another side of the second heating element 312, and a heat insulating strip 302 arranged between the shield plate 301 and the upper heating plate 31. This structure is characterized in higher heating efficiency by arranging the second heating element 312 on the back side of the upper heating plate 31 and heating the articles to be heated in the clamping grooves 321 with the first heating element 34 and the second heating element 312 together. In the embodiment, the second heating element 312 may be a heating plate with built-in heating wire and glued on a back side of the upper heating plate 31 through adhesive, while the first heating element 34 is also a heating plate with built-in heating wire and glued on a back side of the lower heating plate 32 through adhesive. With this arrangement, the first heating element 34 and the second heating element 312 are both heating-wire-built-in heating plates, their heating wires are unexposed to the outside, and thereby providing safety and cleanness. Moreover, the heating plates on the upper heating plate 31 and the lower heating plate 32 are fixed through the adhesive, thus it facilitates mounting.

Further, the rotating shaft device 33 is provided with a first slot and a second slot formed on the outer surface thereof along an axial direction thereof, accordingly the upper heating plate 31 and the shield plate 301 are respectively provided with a first flange 311 matched to the first slot, and a second flange 303 matched to the second slot, which the two flanges are fixed on the rotating shaft device 33 by screws after inserted into the corresponding slots. This structure is convenient for disassembly and assembly and maintenance, the upper heating plate 31 and the shield plate 301 are fixedly connected to the rotating shaft device 33 by means of the first flange 311 and the second flange 303, such that the connection between the upper heating plate 31 and the rotating shaft device 33 are firmer and more reliable, thereby preventing the first flange 311 from fracture under the force of gravity of the shield plate 301 and the upper heating plate 31.

Further, the rotating shaft device 33 is of a hollow structure, and provided with some wire through holes 332 for wiring on a portion thereof between the first slot and the second slot, which are connected to a hollow cavity 331 of the rotating shaft device 33. Due to this, the leads connected with the second heating element 312 are encapsulated in an inner cavity formed by the shield plate 301, the heat insulating strip 302 and the upper heating plate 31, and led to the lower heating plate 32 through the wire through holes 332 and the hollow cavity 331 of the rotating shaft device 33. This facilitates wiring while avoiding the leads from being exposed, increases the aesthetic extent of appearance of the heating plates, effectively avoids wire winding, prolongs the service life of the leads, and facilitates the long-term safe operation for heating plate.

Further, in order to improve the automaticity of the heating system, one or more temperature sensors configured to sense the heating temperature are mounted on the lower heating plate 32. Preferably, the present invention further comprises a temperature controller configured to control the heating temperature. Here, the number and the mounting position of the temperature sensors are not limited, but may be configured flexibly according to actual needs. In an embodiment, an elongated slot 326 in which the temperature sensor is embedded is formed on the back side of the lower heating plate 32. During heating, the heating system may detect the temperature of the lower heating plate 32 in real time by means of the temperature sensor, and transmit signals to the temperature controller to switch on and off the heating elements and/or adjust the power supplied to the heating elements of the heating system, by comparing the real-time measured temperature with a preset temperature, thus achieving constant temperature heating on the articles to be heated.

Further, a travel switch 37, which is triggered by the upper heating plate 31 when the upper heating plate 31 is closed with respect to the lower heating plate 32, is mounted on the upper end face of the lower heating plate 32 in a protruding manner. Only when the upper heating plate 31 is lidded on the lower heating plate 32, the travel switch 37 is triggered by the upper heating plate 31 and the heating system is turned on for heating, avoiding the scalding accidents caused by the upper heating plate 31 and the lower heating plate 32 being started to heat while the upper heating plate 31 and the lower heating plate 32 are not closed, the safety in use of the heating system is thus guaranteed.

When the present invention is applied to gene sequencing, firstly, the biochips are placed in the clamping grooves 321, reagent is added to the biochips manually or with the aid of other automatic devices, after that the excess reagent is cleaned away, and then the motor 381 is turned on to drive the rotating shaft device 33 to rotate with the help of the reduction gear set, thus the upper heating plate 31 is closed with respect to the lower heating plate 32. When the upper heating plate 31 is closed with respect to the lower heating plate 32, the travel switch 37 is triggered by the upper heating plate 31 to turn on the heating system for heating automatically, and the temperature of the lower heating plate 32 is detected in real time through the temperature sensor. The system controls the temperature of the lower heating plate 32 into a certain range to achieve constant temperature heating on the biochips. The invention has a simple and compact structure, and relatively low production costs. The invention provides an automatic opening and closing mechanism for more conveniences in operation.

The upper heating plate 31 and the lower heating plate 32 are hinged together through a rotating shaft device 33, the upper heating plate 31 may be opened and closed along with the rotation of the rotating shaft device 33. The lower heating plate 32 is fixedly connected to the system case 9. The rotating shaft device 33 is arranged on one side of the system case 9 in the X-axis direction, and a motor for driving the rotating shaft device 33 to rotate is arranged therein. The original position of the Y-axis linear execution mechanism 12 is set on another side of the system case 9 in the X-axis direction, the first heating elements 34 for heating are arranged on both of the upper heating plate 31 and the lower heating plate 32 correspondingly. Corresponding to the first heating elements 34, the lower heating plate 32 is further provided with a plurality of clamping grooves 321 where the biochips are placed, and temperature sensors 35 configured to detect the temperature. A heat radiator is arranged under the lower heating plate 32. The lower heating plate 32 is configured as an operation desk for accommodating the biochips during a complete biochip detection process, the biochip detection procedures such as sampling, heating and scanning are all conducted on the lower heating plate 32. In the heating process, the upper heating plate 31 is lidded on the lower heating plate 32 along with the rotation of the rotating shaft device 33, thus achieving rapid heating and temperature control.

The air knife cleaning device comprises an air knife 41 mounted on a bottom end of the third mobile seat 131, and an air pump 42 arranged in a position below the original position of the Y-axis linear execution mechanism 12. The air pump 42 is connected to the air knife 41 through an air pipe and an electromagnetic switch valve configured to control the air flow. The compressed air produced by the air pump 42 is jetted at a high speed through the air knife 41 to blow away the residual sampling liquid on the surface of the biochips instantly, thus protecting the biochip from being polluted.

The biochip scanning system includes a video camera 51 and an intensifying device 52 which are mounted on the third mobile seat 131. The video camera 51 scans the biochips and transmit the pattern information gained to the computer control system for analysis and comparison. The intensifying device 52 plays a role of supplementing light source to ensure a successful scanning of the video camera 51.

The computer control system, comprised of a display, a computer, an electrical electronic controller and a manipulating device, controls the motion execution system, the fluid control system, the temperature control system, the air knife cleaning device and the biochip scanning system via electrical connections.

As a further improvement on the abovementioned embodiments, the system case 9 consists of an execution case 91 and an electronic control case 92. The motion execution system, the fluid control system, the temperature control system, the air knife cleaning device and the biochip scanning system are all mounted in the execution case 91, while the computer control system is mounted in the electronic control case 92. The execution case 91 and the electronic control case 92 are provided with a plurality of connection port groups quickly detachable via cables, and the execution case 91 is further provided with an opening mechanism 911. The detachable design of the system case 9 further improves applicability and flexibility of the detection system.

As a further improvement on the abovementioned embodiments, preferably, the opening mechanism 911 is hinged on the execution case 91 in a rotating manner, a gas spring 912 is connected between the opening mechanism 911 and the execution case 91. A light tube for illumination is arranged within the execution case 91, and the execution case 91 and the electronic control case 92 are further provided with handle grooves at both sides thereof for facilitating transferring.

Further, a motor and a screw rod driven by the motor are arranged in each of the X-axis linear execution mechanism 11, the Y-axis linear execution mechanism 12 and the Z-axis linear execution mechanism 13. The first mobile seat 111, the second mobile seat 121 and the third mobile seat 131 are respectively connected to the screw rods of the X-axis linear execution mechanism 11, the Y-axis linear execution mechanism 12 and the Z-axis linear execution mechanism 13. The Y-axis linear execution mechanism 12 is further provided with a first drag chain 123 and a second drag chain 124 for protecting the movement of the cables and the air pipes. The two ends of the first drag chain 123 are respectively connected to the Y-axis linear execution mechanism 12 and the system case 9. The second drag chain 124, of which the two ends are respectively connected to the Y-axis linear execution mechanism 12 and the second mobile seat 121, is arranged along the Y-axis linear execution mechanism 12. Cables and air pipes may be connected to the Y-axis linear execution mechanism 12 from the system case 9 along the first drag chain 123, and connected to other components such as the mounting box 241 along the second drag chain 124, and thus are protected.

Further, the mounting box 241 is further provided with a waste liquid bottle 261 configured to recycle waste liquid, and a liquid suction pump 26, a liquid suction valve 27, a cleaning solution bottle 281 and a cleaning solution pump 28 which are configured to provide cleaning solution to the liquid adding pipes 23 for cleaning, and a plurality of double check valves 29 connected between the fine control valves 22 and the miniature pumps 21 in a matching manner. The waste liquid bottle 261 is connected to the liquid suction pump 26 through a waste liquid pipe 262, passing through the liquid suction pump 26, the waste liquid pipe 262 is fixed on the sampling needle plate 25 with a tail end thereof. The cleaning solution bottle 281 is connected to the cleaning solution pump 28 through a cleaning solution pipe 282, then connected in parallel to the double check valves 29 and finally connected to the liquid adding pipes 23. The system case 9 is provided with a cleaning bottle 283 located below the Y-axis linear execution mechanism 12 in the original position. By the double check valves 29, the liquid adding pipes 23 may be cleaned by the cleaning solution, selectively, and the cleaning solution is drained into the cleaning bottle 283 from the liquid adding pipes 23 to be stored temporarily, and then sucked into the waste liquid bottle 261 through the waste liquid pipe 262, meanwhile the waste liquid pipe 262 is also capable of sucking the liquid left on the biochip during sampling, and then the air knife cleaning device is turned on for cleaning, thus the amount of the liquid splashed into the system case 9 is reduced and consequently the pollution is reduced.

Further, the first heating elements 34 of the lower heating plate 32 are firmly abutted on the bottom surface of the lower heating plate 32, the temperature sensor 35 is arranged in the center of the bottom surface of the lower heating plate 32. The lower heating plate 32 is further provided with a travel switch 37 configured to control the heating of the heating plates to ensure that the heating operation is carried out only when the upper heating plate 31 is closed with respect to the lower heating plate 32. Furthermore, the lower heating plate 32 is provided with a circular groove 322 encircling the clamping grooves 321 and receiving an elastic sealing strip. The clamping grooves 321 is provided with inclined planes 323 for facilitating taking out the biochips. The heat radiator is provided with a plurality of fans 36 for blowing air in a direction directly to the bottom surface of the lower heating plate 32, and a plurality of vent holes corresponding to the fans are arranged at the bottom of the system case 9, to improve the heat dissipation and ventilating effects. As the biochips are placed on the lower heating plate 32, the first heating elements 34 (not shown in the drawings) of the upper heating plate 31 may be arranged inside the upper heating plate 31, in order to avoid a potential defect caused by exposing the first heating elements 34, e.g., collision with other components, during opening.

Further, the rotating shaft device 33 is of a hollow structure, and provided with some axis holes and wire through holes 332 for leads passing through, such that the leads may go in from the axis holes, and go out from the wire through holes 332 to connect corresponding components, and thus disordered placement of the leads in the system case 9 is avoided.

Further, a filter 45 configured to remove particles from air, an air bag 43 configured to store compressed air, and a pressure regulating valve 44 configured to regulate the output pressure are successively connected between the air pump 42 and the air knife 41, the pressure regulating valve 44 is further connected to a gas-pressure meter for displaying the air pressure value in real time, so as to improve quality and effect of the air jetting of the air knife 41.

Further, the air knife 41 is configured in a wedge shape, and provided with a plurality of air jet holes 411 and circulating holes arranged side by side at a pointed end and two side ends thereof. The air jet holes 411 are mainly used to jet air downwards, and the circulating holes generate wind pressure superposition effect, thereby cleaning the liquid or particles on the biochip more thoroughly.

Further, the intensifying device 52 is mounted below the video camera 51, comprising a lens and a light source for the video camera 51. The video camera 51 scans through the lens to avoid dust in air from attaching to the video camera 51 during cleaning.

The basic operation steps of a biochip detection system of the present invention are as follows.

Firstly, the biochips are placed on the clamping grooves 321 of the lower heating plate 32, and then the computer control system is turned on to control each of the systems to carry out detection with a specific control software. The motion execution system drives the fluid control system and the air knife cleaning device to carry out the work processes of sampling and cleaning the biochips. The sampling needle plate 25 and the air knife 24 may move to each of the biochips along with the Z-axis linear execution mechanism 13 to carry out the work processes of sampling and cleaning. After that, the temperature control system controls the temperature, that is to say, the upper heating plate 31 is closed with respect to the lower heating plate 32, heating the biochips to a specific temperature so as to allow the samples of the biochips to react. After this process, the upper heating plate 31 is opened, and the biochips are cooled to a normal temperature. Finally, after reacted sufficiently, the samples of the biochips is scanned by the biochip scanning system, the sample images gained by the video camera 51 are transmitted to the computer control system, and analyzed and compared with the software thereon, to complete the detection for the biochips. However, each of the work processes may be carried out by a specific or unspecific order, once or repeatedly.

The above descriptions are preferred embodiments of the present invention only, and the present invention shall not be limited thereto. All embodiments, which achieve the technical effects of the present invention by any same or similar means, should fall into the protection scope of the present invention.

1. A biochip detection system, comprising a system case (9), and a motion execution system, a fluid control system, a temperature control system, an air knife cleaning device, a biochip scanning system and a computer control system, which are mounted in the system case (9), wherein:
the motion execution system comprises an X-axis linear execution mechanism (11), a Y-axis linear execution mechanism (12) and a Z-axis linear execution mechanism (13), arranged in an original position perpendicularly to each other along a X-axis direction, a Y-axis direction and a Z-axis direction respectively, wherein the X-axis linear execution mechanism (11) is fixedly mounted on one side of the system case (9) in the Y-axis direction, and comprises a first mobile seat (111) movable along the X-axis direction; the Y-axis linear execution mechanism (12) is arranged above the X-axis linear execution mechanism (11), secured to the first mobile seat (111) by one end thereof, and provided with a mobile bracket (122) on another end thereof; the motion execution system further comprises a guide rail (14) parallel with the X-axis linear execution mechanism (11) and arranged on another side of the system case (9) in the Y-axis direction, wherein the mobile bracket (122) is slidably mounted on the guide rail (14) by a bottom end thereof, the X-axis linear execution mechanism (11) drives the Y-axis linear execution mechanism (12) to move in a form of a gantry; the Y-axis linear execution mechanism (12) comprises a second mobile seat (121) moveable along the Y-axis direction mounted thereon, the Z-axis linear execution mechanism (13) is vertically mounted on the second mobile seat (121) from one side of the Y-axis linear execution mechanism (12), and the Z-axis linear execution mechanism (13) comprises a third mobile seat (131) moveable along the Z-axis direction mounted thereon;
the fluid control system comprises a plurality of miniature pumps (21) configured to suck liquid, fine control valves (22) configured to control flow rate, and liquid adding pipes (23) configured to transfer liquid and connect the miniature pumps (21) and the fine control valves (22), wherein the miniature pumps (21) and the fine control valves (22) are respectively mounted on a mounting box (241) and a mounting plate (242) which are respectively fixedly connected to the second mobile seat (121) and the third mobile seat (131); the mounting box (241) is provided with a plurality of liquid bottles (211) loaded with the liquid arranged thereon, the miniature pumps (21) are correspondingly connected to the liquid bottles (211) and the fine control valves (22) respectively through the liquid adding pipes (23); the fluid control system further comprises a sampling needle plate (25) mounted on a bottom end of the mounting plate (242), and pipe orifices of the liquid adding pipes (23) are concentratedly fixed on the sampling needle plate (25);
the temperature control system comprises an upper heating plate (31) and a lower heating plate (32) which are abutted with each other, and a rotating shaft device (33) through which one end of the upper heating plate (31) and one end of the lower heating plate (32) are hingedly connected, wherein the upper heating plate (31) is openable and closable along with the rotation of the rotating shaft device (33), the lower heating plate (32) is fixedly connected to the system case (9), the rotating shaft device (33) is arranged on one side of the system case (9) in the X-axis direction, and provided with a motor arranged therein for driving the rotating shaft device (33) to rotate, the Y-axis linear execution mechanism (12) has an original position set on another side of the system case (9) in the X-axis direction; the temperature control system further comprises first heating elements (34) arranged on both of the upper heating plate (31) and the lower heating plate (32) correspondingly for heating, the lower heating plate (32) is further provided with a plurality of clamping grooves (321) for receiving the biochips, corresponding to the first heating elements (34); the temperature control system further comprises temperature sensors (35) configured to detect the temperature, and a heat radiator arranged below the lower heating plate (32);
the air knife cleaning device comprises an air knife (41) mounted on a bottom end of the third mobile seat (131), and an air pump (42) arranged below the original position of the Y-axis linear execution mechanism (12), wherein the air pump (42) is connected to the air knife (41) through an air pipe and an electromagnetic switch valve for controlling air flow;
the biochip scanning system comprises a video camera (51) and an intensifying device (52) which are mounted on the third mobile seat (131); and
the computer control system comprises a display, a computer, an electrical electronic controller and an manipulating device, for controlling the motion execution system, the fluid control system, the temperature control system, the air knife cleaning device and the biochip scanning system via electrical connections.

2. The biochip detection system according to claim 1, wherein the system case (9) comprises an execution case (91) in which the motion execution system, the fluid control system, the temperature control system, the air knife cleaning device and the biochip scanning system are mounted, and an electronic control case (92) in which the computer control system is mounted, the execution case (91) and the electronic control case (92) are provided with connection port groups matched with one another and detachable quickly via cables, and the execution case (91) is further provided with an opening mechanism (911) which is openable and closable.

3. The biochip detection system according to claim 2, wherein the opening mechanism (911) is rotatably hinged on the execution case (91), a gas spring (912) is connected between the opening mechanism (911) and the execution case (91), and a light tube is arranged in the execution case (91) for illumination.

4. The biochip detection system according to claim 1, wherein each of the X-axis linear execution mechanism (11), the Y-axis linear execution mechanism (12) and the Z-axis linear execution mechanism (13) is provided with a motor and a screw rod driven by the motor, and the first mobile seat (111), the second mobile seat (121) and the third mobile seat (131) are respectively connected to the screw rod of the X-axis linear execution mechanism (11), the Y-axis linear execution mechanism (12) and the Z-axis linear execution mechanism (13); the Y-axis linear execution mechanism (12) is further provided with a first drag chain (123) and a second drag chain (124) for protecting the movement of the cables and the air pipes, the two ends of the first drag chain (123) are respectively connected to the Y-axis linear execution mechanism (12) and the system case (9), and the second drag chain (124), of which two ends are respectively connected to the Y-axis linear execution mechanism (12) and the second mobile seat (121), is arranged along the Y-axis linear execution mechanism (12).

5. The biochip detection system according to claim 1, wherein the mounting box (241) is further provided with a waste liquid bottle (261), a liquid suction pump (26), and a liquid suction valve (27) for recycling waste liquid, and a cleaning solution bottle (281) and a cleaning solution pump (28) for supplying cleaning solution to the liquid adding pipes (23) for cleaning, and a plurality of double check valves (29) accordingly connected between the fine control valves (22) and the miniature pumps (21); the waste liquid bottle (261) is connected to the liquid suction pump (26) through a waste liquid pipe (262), a tail end of the waste liquid pipe (262) is fixed on the sampling needle plate (25), passing through the liquid suction pump (26); the cleaning solution bottle (281) is connected to the cleaning solution pump (28) through a cleaning solution pipe (282), then connected in parallel to the double check valves (29) and finally connected to the liquid adding pipes (23); and the system case (9) is provided with a cleaning bottle (283) located below the original position of the Y-axis linear execution mechanism (12).

6. The biochip detection system according to claim 1, wherein the first heating elements (34) of the lower heating plate (32) are fixed and abutted on a bottom surface of the lower heating plate (32), the temperature sensor (35) is arranged in a center of the bottom surface of the lower heating plate (32), the lower heating plate (32) is further provided with a travel switch (37) configured to control the heating of heating plates, and a circular groove (322) which encircles the clamping grooves (321) and receives an elastic sealing strip, each of the clamping grooves (321) has an bevel (323) arranged therein for facilitating removing biochips, the heat radiator is provided with a plurality of fans (36) blowing air in a direction directly facing the bottom surface of the lower heating plate (32), and the system case (9) has a plurality of vent holes arranged at a bottom thereof corresponding to the fans.

7. The biochip detection system according to claim 1, wherein the rotating shaft device (33) is of a hollow structure, and provided with axis holes and wire through holes (332) for leads passing through.

8. The biochip detection system according to claim 1, wherein the air knife cleaning device further comprises a filter (45) configured to remove air particles, an air bag (43) configured to store compressed air, and a pressure regulating valve (44) configured to regulate output pressure, which are successively connected between the air pump (42) and the air knife (41), and a gas-pressure meter the pressure connected to the regulating valve (44) and configured to display gas pressure value in real time.

9. The biochip detection system according to claim 1, wherein the air knife (41) is configured to be wedge-shaped, and provided with a plurality of air jet holes (411) and circulating holes which are arranged side by side at a pointed end and two end faces thereof.

10. The biochip detection system according to claim 1, wherein the intensifying device (52) is mounted below the video camera (51), and provided with a lens and a light source corresponding to the video camera (51).

11. A fluid control system for medical detection equipment, comprising a plurality of miniature pumps (21) configured to suck liquid, fine control valves (22) matched with the miniature pumps (21) and configured to control flow rate, liquid adding pipes (23) configured to transfer liquid and connect the miniature pumps (21) and the fine control valves (22), and a sampling needle plate (25) arranged on pipe orifices on tail ends of the liquid adding pipes (23) passing through the fine control valves (22) to gather and secure the liquid adding pipes (23), wherein the miniature pumps (21) are connected to liquid bottles (211) loaded with sampling liquid and the fine control valves (22) through the liquid adding pipes (23) respectively.

12. The fluid control system for medical detection equipment according to claim 11, further comprising a liquid suction pump (26) configured to suck the liquid sampled, which is connected to a waste liquid bottle (261) configured to recycle waste liquid and the fine control valves (22) through liquid suction pipes, wherein tail ends of the liquid suction pipes passing through the fine control valves (22) are secured on the sampling needle plate (25).

13. The fluid control system for medical detection equipment according to claim 12, further comprising a mounting box (241) on which the liquid bottles (211) and the waste liquid bottle (261) are arranged, a mounting plate (242) to of which a middle section and a bottom end the fine control valves (22) and the sampling needle plate (25) are respectively fixedly connected, and a mobile manipulator moveable in space on which the mounting plate (242) and the mounting box (241) are fixed, wherein the mounting box (241) is provided with a mounting base on which the miniature pumps (21) and the liquid suction pump (26) are mounted, the mounting plate (242) is vertically connected to one side of a bottom end of the mobile manipulator, and the mounting box (241) is connected to one side of a top end of the mobile manipulator.

14. The fluid control system for medical detection equipment according to claim 13, wherein the liquid adding pipes (23) between the miniature pumps (21) and the fine control valves (22) are further provided with double check valves (29) which select the pipes for liquid to pass through, wherein the double check valves (29) are simultaneously connected to two liquid adding pipes (23) for respectively transferring cleaning solution and the sampling liquid, the liquid adding pipe (23) for transferring the cleaning solution is connected to a cleaning pump configured to supply the cleaning solution alone, the two liquid adding pipes (23) passing through the double check valves (29) are jointed into one liquid adding pipe (23) and connected to the fine control valves (22).

15. The fluid control system for medical detection equipment according to claim 14, wherein the double check valves (29) together with the fine control valves (22) connected to the liquid suction pump (26) are mounted on the mounting base.

16. The fluid control system for medical detection equipment according to claim 13, further comprising a liquid containing bottle configured to correspondingly receive the liquid drained from the liquid adding pipes (23) and arranged below the mobile manipulator.

17. The fluid control system for medical detection equipment according to claim 16, wherein the liquid containing bottle is arranged below an original position of the mobile manipulator.

18. A temperature control system for medical detection equipment, comprising:
a lower heating plate (32), fixedly mounted in a case of the medical detection equipment;
a first heating element (34), mounted on a lower end face of the lower heating plate (32) for heating;
the lower heating plate (32) having a heating region on an upper end face thereof corresponding to the first heating element (34), in which a plurality of clamping grooves (321) for receiving biochips are arranged;
an upper heating plate (31), hingedly mounted on an end of the lower heating plate (32);
a driving device, configured to drive the upper heating plate (31) to rotate, and comprising a motor (381) and a transmission mechanism (382); and
a heat radiator, arranged below the lower heating plate (32), and comprising a radiator mounting rack (362) fixedly connected to the lower heating plate (32), and radiator fans (36) mounted on the radiator mounting rack (362), wherein the radiator mounting rack (362) is provided with vent holes (363) in positions corresponding to where the radiator fans (36) are located.

19. The temperature control system for medical detection equipment according to claim 18, wherein the lower heating plate (32) has a circular groove (322) formed on a periphery of the heating region thereof, in which an elastic sealing element is embedded and pressed by the lower heating plate (32) to deform to seal the heating region when the upper heating plate (31) is closed with respect to the lower heating plate (32).

20. The temperature control system of medical detection equipment according to claim 18, wherein each of the clamping grooves (321) is provided with a bevel (323) on a bottom surface at one end thereof, sloping downward to facilitate an article heated escaping from the clamping groove (321) from another end opposite to this end while the article heated is pressed at this end.

21. The temperature control system of medical detection equipment according to claim 18, wherein the upper heating plate (31) is flexibly connected to one end of the lower heating plate (32) through a rotating shaft device (33), and two ends of the rotating shaft device (33) are flexibly connected to a first supporting seat (391) and a second supporting seat (392) through bearings, the first supporting seat (391) is close to the motor (381) and fixedly mounted on the lower heating plate (32) along with the second supporting seat (392).

22. The temperature control system for medical detection equipment according to claim 21, further comprising a mounting flange (324) for fixedly mounting a motor (381), arranged on one end of the lower heating plate (32) where the rotating shaft device (33) is connected, wherein the lower heating plate (32) has a notch (325) formed at a side thereof facing the mounting flange (324), and the rotating shaft device (33), the first supporting seat (391) and the second supporting seat (392) are all arranged in the notch (325), and the driving device is a reduction gear set and mounted in the first supporting seat (391).

23. The temperature control system for medical detection equipment according to claim 18, further comprising a second heating element (312) mounted in a position on a back side of the upper heating plate (31) corresponding to where the first heating element (34) is located, a shield plate (301) fixedly connected to the upper heating plate (31) and arranged on another side of the second heating element (312), and a heat insulating strip (302) arranged between the shield plate (301) and the upper heating plate (31) for preventing heat loss.

24. The temperature control system for medical detection equipment according to claim 23, wherein a rotating shaft device (33) has a first slot and a second slot formed on an outer surface thereof along an axial direction thereof, each of the upper heating plate (31) and the shield plate (301) is provided with a first flange (311) matched to the first slot and a second flange (303) matched to the second slot, and the first flange and the second flange are fixed on the rotating shaft device (33) through screws after inserted into the corresponding slots.

25. The temperature control system for medical detection equipment according to claim 24, wherein the rotating shaft device (33) is of a hollow structure, and has wire through holes (332) for wiring on a portion thereof between the first slot and the second slot, which are connected to a hollow cavity (331) of the rotating shaft device (33).

26. The temperature control system for medical detection equipment according to claim 18, further comprising one or more temperature sensors mounted on the lower heating plate (32) and configured to sense heating temperature.

27. The temperature control system for medical detection equipment according to claim 18, further comprising a travel switch (37) mounted on an upper end face of the lower heating plate (32) and triggered by the upper heating plate (31) when the upper heating plate (31) is closed with respect to the lower heating plate (32).
